(19) United States
(12) Patent Application Publication
(10) Pub. No.: US 2009/0032324 A1
(43) Pub. Date: Feb. 5, 2009

(54) VEHICLE WITH DUAL STEERING MECHANISMS

(75) Inventors: Yasuhiro Suzuki, Shizuoka (JP); Kaoru Haruna, Shizuoka (JP)

Correspondence Address: JONES DAY, 555 SOUTH FLOWER STREET FIFTIETH FLOOR, LOS ANGELES, CA, 90071, US

(73) Assignee: Yamaha Hatsudoki Kabushiki Kaisha, Shizuoka-ken (JP)

(21) Appl. No.: 11/831,988

(22) Filed: Aug. 1, 2007

(51) Int. Cl. B62D 7/00; B60K 17/34

(52) U.S. Cl. 180/240; 180/234

(57) ABSTRACT

A vehicle having front and rear wheels includes a front wheel steering mechanism for providing a steering angle to a front wheel. Also, a rear wheel steering mechanism provides a steering angle to a rear wheel. The rear wheel steering mechanism has a first and second operational position; wherein the second operational position of the rear wheel steering mechanism is dependent upon the front wheel steering mechanism achieving a first predetermined steering state, preferably the steering through a prescribed angle or greater.

### 1 FIELD OF THE INVENTION

The present invention relates to a vehicle and, in particular, to an all terrain vehicle provided with front and back wheel steering mechanisms for providing steering angles to front and rear wheels upon certain predetermined conditions.

### 2. DESCRIPTION OF BACKGROUND ART

Conventionally, it is known to provide an all terrain vehicle with an assisted driving source for assisting a steering force to provide a steering angle to front wheels. Such an all terrain vehicle is disclosed in, for example, JP-A-2006-232061.

In particular, JP-A-2006-232061 discloses a saddle type four-wheeled vehicle (all terrain vehicle) provided with an electric power steering system having a power assist motor (driving source) for reducing the steering force required to provide a steering angle to front wheels.

However, the electric power steering system of the saddle type four-wheeled vehicle (all terrain vehicle) disclosed in JP-A-2006-232061 has a limitation in improving the steering performance, such as turning performance, as the system is designed to solely provide steering angle assistance to the front wheels of the saddle type four-wheeled vehicle.

### 3. SUMMARY OF THE INVENTION

Accordingly, it is an object of the present invention to provide a vehicle and in particular an all-terrain vehicle with improved steering performance.

For the purpose of accomplishing the above objective, a vehicle according to a first aspect of this invention includes dual steering mechanisms. A front wheel steering mechanism provides a steering angle to front wheels. The vehicle also includes a rear wheel steering mechanism for providing a steering angle to rear wheels. The operation of the rear wheel steering mechanism is dependent upon the operation of the front wheel steering mechanism. In particular the rear wheel steering mechanism has a first operational position and a second operational position wherein the second operational position is obtained when the first wheel steering mechanism achieves a first predetermined steering state.

In an additional embodiment, a driving source may assist a steering force to provide a steering angle to the front wheels alone or in combination with the rear wheels.

Since the all terrain vehicle according to the first aspect of the invention has a rear wheel steering mechanism with an operational position condition upon the front wheel steering mechanism for providing a steering angle to the rear wheels, the turning radius of the all terrain vehicle may be decreased when necessary. This may occur when the front wheel steering mechanism provides a steering angle to the front wheels at an angle greater than a predetermined angle. This results in improved steering performance of the all terrain vehicle.

Also, since the rear wheel steering mechanism has a first operational position distinct from the second operational position wherein the front wheel is turning at a predetermined angle, the all terrain vehicle can be steered with the vehicle body oriented forwards as in high speed operation. Therefore, the all terrain vehicle can travel with an inertia force in the forward direction which the vehicle body has maintained.

In an additional embodiment, a driving source for assisting the steering force to provide a steering angle to the front wheels is provided. Additionally, if the rear wheel steering mechanism is connected to the front wheel steering mechanism, the driving force of the driving source can be used as a driving force for the rear wheel steering mechanism. Therefore, the steering force the rider needs to provide a steering angle to the front wheels and the rear wheels can be decreased.

An additional aspect of the present invention involving the first wheel steering mechanism is that the first predetermined steering state relates to the steering angle of the front wheels. Preferably, the rear wheel steering mechanism manipulates the steering angle of the rear wheels when the front wheel steering mechanism is steered through a prescribed angle or greater. In this configuration, the rear wheel steering mechanism is operated in the second operational position such that a steering angle in a direction opposite to the direction of the steering angle provided to the front wheels is provided to the rear wheels thereby decreasing the turning radius of the all terrain vehicle. This is preferably only done when the front wheel steering mechanism is steered through a prescribed angle or greater to decrease the turning radius.

In a further aspect of the present invention the front wheel steering mechanism includes a first rocking member which is rocked when a steering angle is provided to the front wheels; and a front wheel moving member connected to the first rocking member for providing a steering angle to the front wheels when the first rocking member is rocked. In this configuration, the first rocking member can be rocked by the steering force applied to the front wheel steering mechanism, and a steering angle can be easily provided to the front wheels by the front wheel moving member connected to the first rocking member.

An additional aspect of the present invention is the inclusion of a transmission mechanism for transmitting the steering force of the front wheel steering mechanism assisted by the driving source to the rear wheel steering mechanism. In an additional configuration, the transmission mechanism includes a transmitting member connected to the first rocking member of the front wheel steering mechanism for transmitting the steering force of the front wheel steering mechanism to the rear wheel steering mechanism side; and a second rocking member which is connected to the transmitting member and which is rocked by the steering force of the front wheel steering mechanism transmitted by the transmitting member to transmit the steering force of the front wheel steering mechanism to the rear wheel steering mechanism. In this configuration, the steering force transmitted to the first rocking member of the front wheel steering mechanism can be transmitted to the rear wheel steering mechanism via the transmitting member and the second rocking member. Preferably, in this aspect, a wire member is utilized as the transmitting member for transmitting the steering force of the front wheel steering mechanism to the rear wheel steering mechanism side can be easily obtained.

In an additional configuration, the rear wheel steering mechanism includes a third rocking member which is rocked when the second rocking member of the transmission mechanism is rocked; and a rear wheel moving member for providing a steering angle to the rear wheels when the third rocking member is rocked. In this configuration, the steering force applied to the front wheel steering mechanism can be transmitted to the third rocking member of the rear wheel steering mechanism via the second rocking member of the transmission mechanism to rock the third rocking member, and a steering angle can be easily provided to the rear wheels by the rear wheel moving member. In this additional configuration, preferably the second rocking member of the transmission mechanism includes a first gear part, and the third rocking member of the rear wheel steering mechanism includes a second gear part which can be brought into meshing engagement with the first gear part. In this configuration, the second gear part of the third rocking member can be easily rotated when the first gear part of the second rocking member is rotated.

Preferably, in the all terrain vehicle, in which the third rocking member includes a second gear part which can be brought into meshing engagement with the first gear part, the first gear part of the transmission mechanism is brought into meshing engagement with the second gear part of the rear wheel steering mechanism when the front wheel steering mechanism achieves a first predetermined steering state which may be a prescribed angle or greater. In this configuration, the rear wheel steering mechanism can be easily steered when the front wheel steering mechanism is steered through a prescribed angle or greater.

An additional aspect of the present invention involves decreasing the turning radius of the vehicle. In this aspect, preferably, the all terrain vehicle has a third rocking member including a second gear which can be brought into meshing engagement with the first gear when the first wheel steering mechanism achieves a first predetermined steering state. When the first rocking member of the front wheel steering mechanism is rocked in one direction, the front wheels are steered in one direction, and the second rocking member is rocked in one direction via the transmitting member of the transmission mechanism such that when the first gear part of the second rocking member is rotated in one direction, the second gear part of the third rocking member of the rear wheel steering mechanism is rotated in the opposite direction, whereby the third rocking member is rocked in the opposite direction and the rear wheels are steered in the opposite direction.

Preferably in the aspect where the all terrain vehicle includes the rear wheel steering mechanism having a third rocking member which is rocked when the second rocking member of the transmission mechanism is rocked, the third rocking member of the rear wheel steering mechanism includes a roller part which is brought into contact with the second rocking member when the front wheel steering mechanism is steered through an angle smaller than a prescribed angle, and which is released from the contact with the second rocking member when the front wheel steering mechanism is steered through a prescribed angle or greater. In this configuration, when the front wheel steering mechanism is steered through an angle smaller than a prescribed angle, the roller part is brought into contact with the second rocking member to prevent the third rocking member from being rocked. Therefore, no steering angle is provided to the rear wheels and the rear wheel steering mechanism is operating in a first operational position. When the front wheel steering mechanism is steered through a prescribed angle or greater, the second rocking member, which has been in contact with the roller part, is released from the contact with the roller part to allow the third rocking member to be rocked thereby enabling the second steering mechanism to operation in a second operational position. As a result, a steering angle can be provided to the rear wheels.

Another aspect of the present invention involves the driving source including a motor having a drive shaft extending in a direction across a steering shaft of the front wheel steering mechanism. In this configuration, a driving force to assist the steering force can be easily applied to the front wheel steering mechanism.

Preferably, in the all terrain vehicle, in which the driving source includes a motor, the front wheel steering mechanism further includes a steering force detection device for detecting the steering force applied by the rider when the front wheel steering mechanism is steered, and the driving force of the motor to assist the steering force is controlled based on the magnitude of the steering force applied by the rider and detected by the steering force detection device. In this configuration, when the front wheel steering mechanism is steered, an appropriate steering force can be applied to the front wheel steering mechanism. Therefore, an appropriate steering angle can be provided to the front wheels.

Preferably, in the all terrain vehicle, in which the driving source includes a motor, the driving force of the motor is greater when the front wheel steering mechanism is steered through a prescribed angle or greater than when the front wheel steering mechanism is steered through an angle smaller than the prescribed angle. In this configuration, when a steering angle is provided to the rear wheels when the front wheel steering mechanism is steered through a prescribed angle or greater, the steering force of the rear wheel steering mechanism, as well as the steering force of the front wheel steering mechanism, can be assisted.

Preferably, in this case, the front wheel steering mechanism further includes a steering angle detection device for detecting the steering angle provided by the rider when the front wheel steering mechanism is steered, and the driving force of the motor to assist the steering force is controlled based on the steering angle provided by the rider when the steering angle provided by the rider is detected by the steering angle detection device. In this configuration, since the angle through which the front wheel steering mechanism is steered can be easily detected by the steering angle detection device, when a steering angle is provided to the rear wheels when the front wheel steering mechanism is steered through a prescribed angle or greater, the driving force to assist the steering force can be easily increased.

Preferably, the all terrain vehicle according to the first aspect further includes: an engine; a front output shaft for transmitting a driving force from the engine to the front wheels; a rear output shaft for transmitting a driving force from the engine to the rear wheels; and a differential device provided between the front output shaft and the front wheels for connecting and disconnecting the driving force to be transmitted to the front wheels. In this configuration, the all terrain vehicle can be switched between two-wheel drive and four-wheel drive.

Preferably, the all terrain vehicle according to the first aspect is a four-wheeled vehicle. In this configuration, an all terrain vehicle which can travel stably can be obtained.

### 4. BRIEF DESCRIPTION OF THE DRAWINGS

FIG. 1 is a side view illustrating the overall structure of an ATV (all terrain vehicle) according to an embodiment of the present invention.

FIG. 2 is a plan view illustrating the structure of the ATV (all terrain vehicle) according to the embodiment shown in FIG. 1.

FIG. 3 is a plan view illustrating the structure of the ATV (all terrain vehicle) according to the embodiment shown in FIG. 1.

FIG. 4 is a cross-sectional view illustrating the structure around a front wheel steering mechanism of the ATV (all terrain vehicle) according to the embodiment shown in FIG. 1.

FIG. 5 is a plan view illustrating the structure around a front wheel steering mechanism of the ATV (all terrain vehicle) according to the embodiment shown in FIG. 1.

FIG. 6 is a plan view illustrating the structure around a rear wheel steering mechanism of the ATV (all terrain vehicle) according to the embodiment shown in FIG. 1.

FIG. 7 is a cross-sectional view illustrating the structure around the rear wheel steering mechanism of the ATV (all terrain vehicle) according to the embodiment shown in FIG. 1.

FIG. 8 is a plan view for explaining the operation of the front wheel steering mechanism and the rear wheel steering mechanism of the ATV (all terrain vehicle) according to the embodiment shown in FIG. 1.

FIG. 9 is a plan view for explaining the operation of the rear wheel steering mechanism of the ATV (all terrain vehicle) according to the embodiment shown in FIG. 1.

FIG. 10 is a plan view for explaining the operation of the front wheel steering mechanism and the rear wheel steering mechanism of the ATV (all terrain vehicle) according to the embodiment shown in FIG. 1.

FIG. 11 is a plan view for explaining the operation of the rear wheel steering mechanism of the ATV (all terrain vehicle) according to the embodiment shown in FIG. 1.

FIG. 12 is a cross-sectional view illustrating the structure around a front wheel steering mechanism of an ATV (all terrain vehicle) according to a modification of the embodiment of the present invention.

### 5. DESCRIPTION OF PREFERRED EMBODIMENT

Description is hereinafter made of the embodiment of the present invention with reference to the drawings.

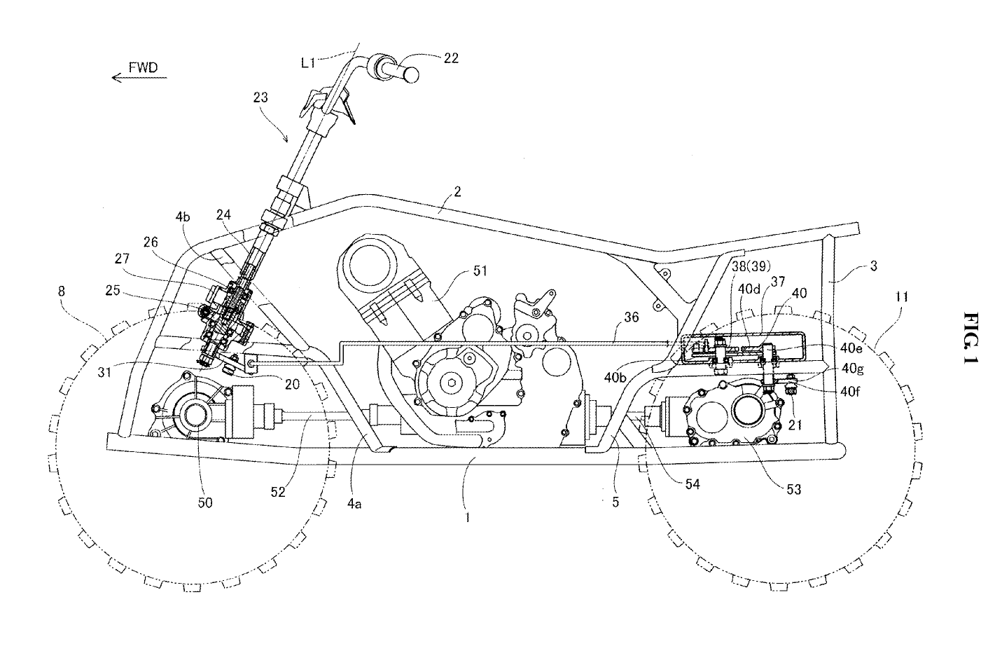

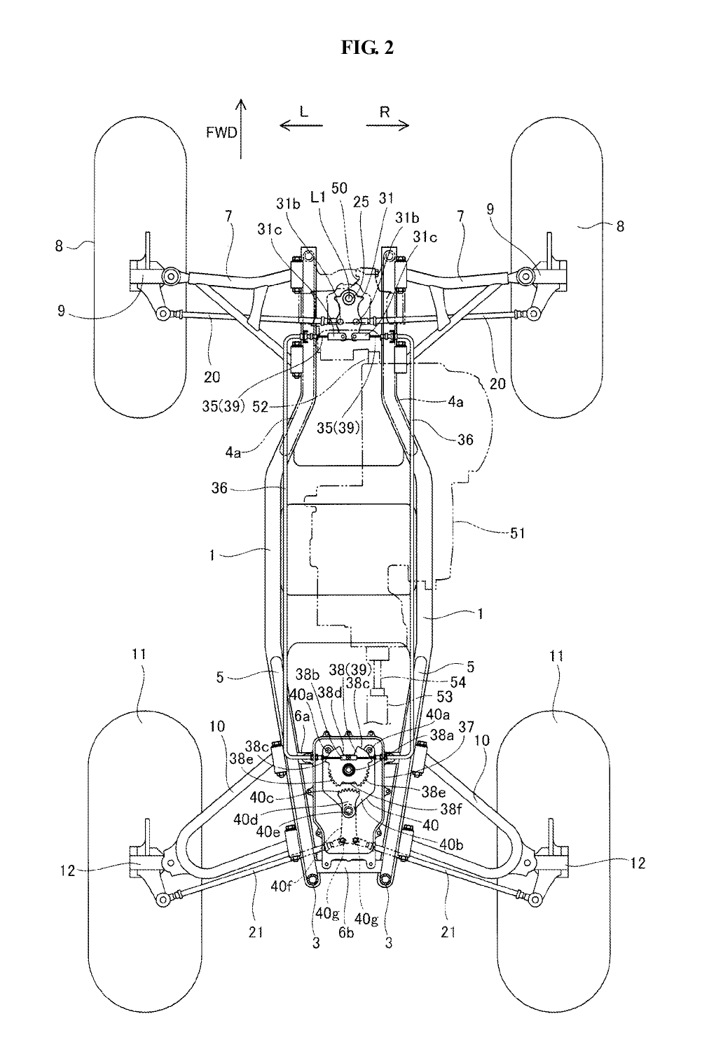

Referring to FIG. 1 to FIG. 7, the structure of an ATV (All Terrain Vehicle) according to an embodiment of the present invention is described in detail. In this embodiment, a four-wheeled ATV is described as an example of the all terrain vehicle of the present invention. In the drawings, an arrow FWD indicates the front of the traveling direction of the ATV.

As shown in FIGS. 1, 2 and 3, the ATV according to the embodiment of the present invention has main frames 1 extending from front to rear of the vehicle body. The front ends of the main frames 1 are secured to the front ends of upper frames 2. Back stays 3 are secured between the rear ends of the main frames 1 and the rear ends of the upper frames 2. Lower front stays 4a connected to front parts of the upper frames 2 are secured to front parts of the main frames 1. Upper front stays 4b connected to upper parts of the lower front stays 4a are secured to upper front parts of the upper frames 2. Lower rear stays 5 connected to the back stays 3 are secured to rear parts of the main frames 1. Reinforcing members 6a and 6b are secured between the lower rear stay 5 on the arrow L side (left side) and the lower rear stay 5 on the arrow R side (right side).

Upper arms (not shown) and lower arms 7 are attached to the front ends of the upper frames 2 and the front ends of the main frames 1. Hubs 9 for supporting front wheels 8 are attached to the upper arms (not shown) and the lower arms 7. Tie rods 20 for providing a steering angle to the front wheels 8 via the hubs 9 are movably attached to the hubs 9. The tie rods 20 are one example of the “front wheel moving member” of the present invention. In this embodiment, a front gear case 50 for transmitting a driving force to the front wheels 8 is attached to front parts of the main frames 1. The front gear case 50 is one example of the “differential device” of the present invention. The front wheels 8 are located on both sides of the front gear case 50.

In this embodiment, a front shaft 52 for transmitting a driving force from an engine 51 to the front wheels 8 is connected to the front gear case 50. The front gear case 50 is located between the front shaft 52 and the front wheels 8. The front shaft 52 is one example of the “front output shaft” of the present invention. The front gear case 50 is configured to be capable of connecting and disconnecting the driving force to the front wheels 8. That is, the ATV according to this embodiment can be switched between two-wheel drive and four-wheel drive. Upper arms (not shown) and lower arms 10 are attached to the back stays 3 and rear parts of the main frames 1. Hubs 12 for supporting rear wheels 11 are attached to the upper arms (not shown) and the lower arms 10. Tie rods 21 for providing a steering angle to the rear wheels 11 via the hubs 12 are movably attached to the hubs 12. The tie rods 21 are one example of the “rear wheel moving member” of the present invention.

A rear gear case 53 for transmitting a driving force from the engine 51 to the rear wheels 11 is attached to rear parts of the main frames 1. A rear shaft 54 for transmitting a driving force from the engine 51 to the rear wheels 11 is connected to the rear gear case 53. The rear gear case 53 is located between the rear shaft 54 and the rear wheels 11. The rear shaft 54 is one example of the “rear output shaft” of the present invention.

A handle bar 22 is provided above front parts of the upper frames 2 for rotation about an axis of rotation L1. The handle bar 22 is connected to a steering shaft part 23, and the central axis of the steering shaft part 23 is generally coincident with the axis of rotation L1. The steering shaft part 23 is one example of the “steering shaft” of the present invention.

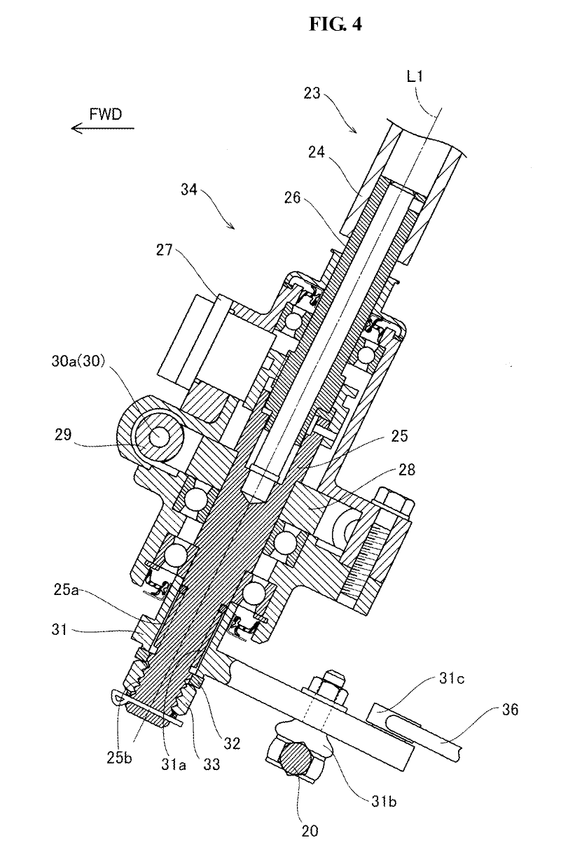

As shown in FIG. 4, the steering shaft part 23 includes an upper shaft part 24, a lower shaft part 25, and a torsion bar 26 interposed between the upper shaft part 24 and the lower shaft part 25.

Since the upper shaft part 24 is connected to the handle bar 22, when the rider operates the handle bar 22 to apply a steering force to the handle bar 22, the upper shaft part 24 rotates about the axis of rotation L1.

The torsion bar 26 is fixed to the upper shaft part 24 and also fixed to the lower shaft part 25.

The torsion bar 26 has a function of deforming elastically with a prescribed elastic force in a circumferential direction about the axis of rotation L1. More specifically, when the upper shaft part 24 is rotated in one direction and the steering force is transmitted to the lower shaft part 25 via the torsion bar 26, a steering angle is provided to the front wheels 8. At this time, the lower shaft part 25 receives a resistive force in the opposite direction caused by the friction between the front wheels 8 and the ground surface. As a result, an upper part of the torsion bar 26 is rotated in one direction and a lower part of the torsion bar 26 is rotated in the opposite direction, and the torsion bar 26 is twisted about the axis of rotation L1. Additionally, in the event wherein the front wheel steering mechanism has achieved a first predetermined steering state and is at or greater to a prescribed steering angle, then the rear wheel steering mechanism will be engaged so that the resistive force of the rear wheels are also directed to torsion bar 26.

A potentiometer 27 is disposed on a front part of the torsion bar 26. The potentiometer 27 has a function of detecting the torque of the torsion bar 26 when the torsion bar 26 is twisted. That is, the potentiometer 27 has a function of detecting the steering force applied by the rider when the handle bar 22 is steered. The potentiometer 27 is one example of the “steering force detection device” of the present invention.

A worm wheel 28 is fitted on an upper part of the lower shaft part 25 in such a manner that the worm wheel 28 does not rotate freely relative to the lower shaft part 25. A worm 29 is rotatably engaged with the worm wheel 28. A drive shaft 30a of a motor 30 is inserted in the worm 29. The motor 30 is attached with its drive shaft 30a extending in a direction across the lower shaft part 25. The worm 29 is rotatable together with the drive shaft 30a. The driving force of the motor 30 is controlled based on the torque of the torsion bar 26 detected by the potentiometer 27. That is, the motor 30 is controlled to assist the steering force based on the magnitude of the steering force applied by the rider. When the friction between the front wheels 8 and the ground surface is large, the driving force is increased so that the steering force which the rider needs to apply to provide a steering angle to the front wheels 8 and the rear wheel 11 can be decreased. This also occurs when the rear wheel steering mechanism are applying a steering angle to the rear wheels.

A splined engaging part 25a is formed on a lower part of the lower shaft part 25, and a threaded part 25b is formed below the engaging part 25a. The engaging part 25a of the lower shaft part 25 is fitted in a rocking center hole 31a of a pitman arm 31 in such a manner that the pitman arm 31 does not rotate freely relative to the lower shaft part 25. That is, the pitman arm 31 is attached to the lower shaft part 25 in such a manner that it does not rotate freely relative to the lower shaft part 25. The pitman arm 31 is capable of providing a steering angle to the front wheels 8 when rocked. A nut 33 is fixed to the threaded part 25b via a washer 32 to support the pitman arm 31 so that the pitman arm 31 cannot come off the engaging part 25a. The pitman arm 31 is one example of the “first rocking member” of the present invention. In the preferred embodiment, the hubs 9, the tie rods 20, the handle bar 22, the steering shaft part 23 and the pitman arm 31 are disclosed for defining a front wheel steering mechanism 34. However, to one of ordinary skill in the art, other front wheel steering mechanisms may be utilized in order to deliver a steering angle to the front wheels.

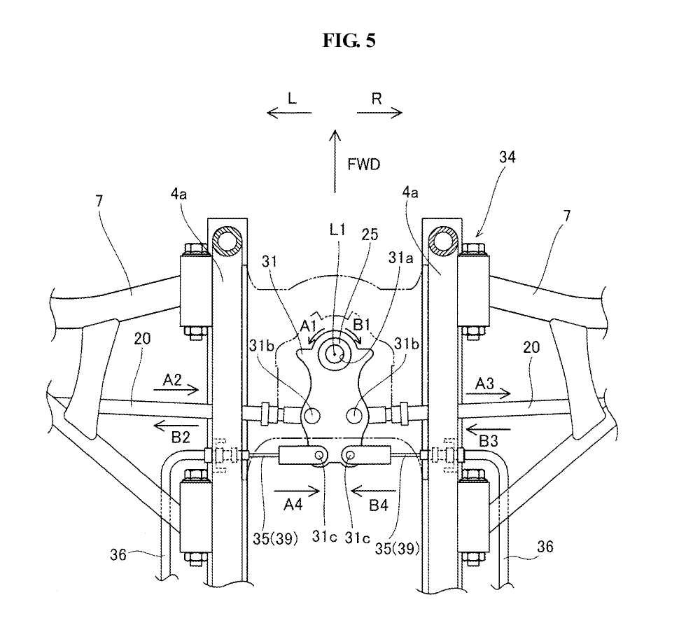

As shown in FIG. 5, the rocking center hole 31a of the pitman arm 31 may be formed through a front (the arrow FWD side) part of the pitman arm 31. Behind the rocking center hole 31a, a pair of tie rod attaching parts 31b are formed to which the left and right (the arrow L side and the arrow R side) tie rods 20 are attached. Thus, when the pitman arm 31 is rotated in the A1 direction (counterclockwise) about the rocking center hole 31a (axis of rotation L1), the arrow L side (left) tie rod 20 can be moved in the arrow A2 direction (rightward) and the arrow R side (right) tie rod 20 can be moved in the arrow A3 direction (rightward). When the pitman arm 31 is rotated in the B1 direction (clockwise) about the rocking center hole 31a (axis of rotation L1), the arrow L side (left) tie rod 20 can be moved in the arrow B2 direction (leftward) and the arrow R side (right) tie rod 20 can be moved in the arrow B3 direction (leftward). Therefore, when the pitman arm 31 is rocked, a steering angle can be provided to the front wheels 8, to which the tie rods 20 are attached via the hubs 9.

In this embodiment, behind the tie rod attaching parts 31b, wire attaching parts 31c are formed to which first (front) ends of left and right (arrow L side and arrow R side) wire member 35 are connected. Thus, when the pitman arm 31 is rotated in the A1 direction (counterclockwise) about the rocking center hole 31a (axis of rotation L1), the arrow L side (left) wire member 35 can be moved in the arrow A4 direction. Also, when the pitman arm 31 is rotated in the B1 direction (clockwise) about the rocking center hole 31a (axis of rotation L1), the arrow L side (left) wire member 35 can be moved in the arrow B4 direction. The wire members 35 are only one example of the “transmitting member or linkage” of the present invention. Additional linkage structures exist which are known to one of skill in the art. Also, since the wire members 35 are connected to the output side of the motor 30 of the front wheel steering mechanism 34, a steering force can be transmitted to the wire members 35 using the driving force of the motor 30.

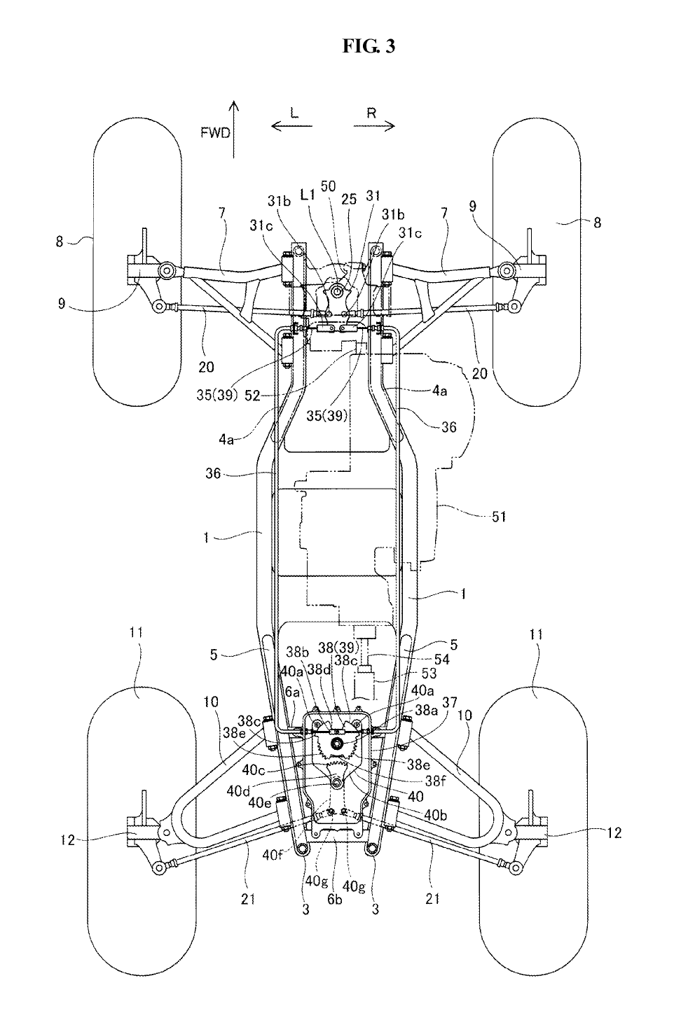

Also, in the preferred embodiment as shown in FIG. 1 and FIG. 3, the left and right (arrow L side and arrow R side) wire members 35 (see FIG. 3) are inserted in a metal pipes 36 extending toward the rear of the ATV and extend into a case 37 (see FIG. 3).

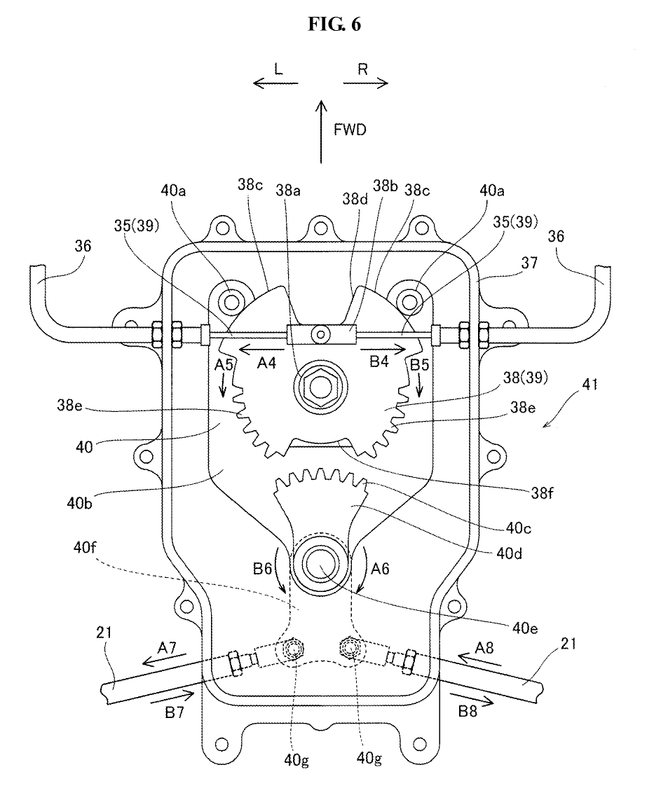

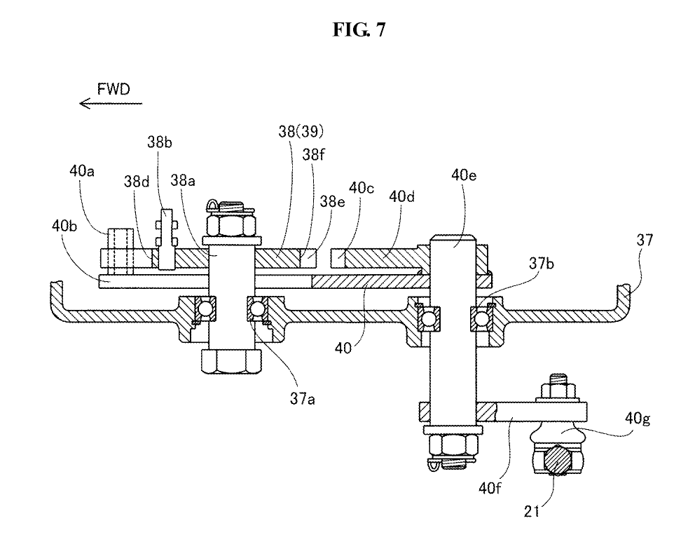

In this embodiment as shown in FIG. 6, the second (rear) ends of the wire members 35 extending into the case 37 may be attached to a wire attaching part 38b of a rocking member 38 in front (on the arrow FWD side) of a pivot shaft part 38a. The rocking member 38 is fixed for rotation relative to the bottom of the case 37 as shown in FIG. 6 and FIG. 7. More specifically, the pivot shaft part 38a of the rocking member 38 is received in a bearing 37a (see FIG. 7) attached to the bottom of the case part 37. Thus, the rocking member 38 can rotate in the A5 direction (counterclockwise) when pulled by the wire members 35 in the arrow A4 direction and can rotate in the B5 direction (clockwise) when the wire members 35 are pulled in the arrow B4 direction. The rocking member 38 is one example of the “second rocking member” of the present invention. As illustrated in this specification, the wire members 35 and the rocking member 38 are disclosed as one example of a transmission mechanism 39. Other examples of a transmission mechanism 39 may be had as long as they function to transmitting the steering force of the front wheel steering mechanism 34 to a rear wheel steering mechanism 41, which is described later.

In this embodiment, a pair of receiving parts 38c having an arcuate shape about the pivot shaft part 38a are formed on both left and right sides (arrow L side and arrow R side) of a front (arrow FWD side) peripheral part of the rocking member 38. A front notch part 38d cut out toward the center of the pivot shaft part 38a is provided between the paired receiving parts 38c. A pair of gear parts 38e having a gear-like shape are formed on both sides (arrow L side and arrow R side) of a rear peripheral part of the rocking member 38. The gear parts 38e are one example of the “first gear part” of the present invention. A rear notch part 38f cut out toward the center of the pivot shaft part 38a is provided between the paired gear parts 38e.

In this embodiment, a pair of roller parts 40a of the pitman arm 40 are in rotatable contact with the paired receiving parts 38c of the rocking member 38. The pitman arm 40 is one example of a “third rocking member.” The hubs 12, the tie rods 21, and the pitman arm 40 are disclosed as providing one example of a rear wheel steering mechanism 41.

In this embodiment, the pitman arm 40 has a plate member 40b bifurcated to the arrow L side and arrow R side toward the arrow FWD direction as shown in FIG. 6 and FIG. 7. The paired roller parts 40a extending upward are located at the ends of the plate member 40b bifurcated to the arrow L side and arrow R side. The paired roller parts 40a have a function of preventing the plate member 40b from being rocked in the A6 direction (clockwise) or the B6 direction (counterclockwise) when in contact with the paired receiving parts 38c of the rocking member 38. The roller parts 40a are released from the contact with the paired receiving parts 38c when the rocking member 38 is rotated in the A5 direction (counterclockwise) or the B5 direction (clockwise) through an angle equal to or greater than a prescribed angle. An upper plate member 40d located on the upper side of the plate member 40b and having a sector-shaped gear part 40c on its arrow FWD side is joined to a rear part of the plate member 40b by welding.

When a steering angle of approximately 35° in the arrow L direction or arrow R direction with respect to the arrow FWD direction is provided to the front wheels 8, the rocking member 38 is rotated through a prescribed angle in the A5 direction or the B5 direction. The gear part 40c is brought into meshing engagement with one of the gear parts 38e when the rocking member 38 is rotated in the A5 direction or the B5 direction through an angle equal to or greater than a prescribed angle. Thus, the pitman arm 40 is not rotated when the rocking member 38 is rotated through an angle smaller than the prescribed angle but is rotated when the rocking member 38 is rotated through an angle equal to or greater than the prescribed angle. Thus, when the first wheel steering mechanism achieves a first predetermined steering state, i.e. greater than the prescribed angle, the rear wheels are also steered via the rear wheel steering mechanism operating in a second operational condition.

A pivot shaft part 40e is attached to the rear end of the plate member 40b and the rear end of the upper plate member 40d and extends downward as shown in FIG. 7. The pivot shaft part 40e extends through the bottom of the case part 37. More specifically, the pivot shaft part 40e is received by a bearing 37b attached to the bottom of the case part 37 and extends downward beyond the bottom of the case part 37.

As shown in FIG. 6, in this embodiment, a tie rod attaching member 40f is attached to a lower part of the pivot shaft part 40e. The tie rod attaching member 40f extends backward and attached in such a manner that it does not rotate freely relative to the pivot shaft part 40e. That is, the tie rod attaching member 40f is rotatable in the same direction and through the same angle as the plate member 40b and the upper plate member 40d. A pair of tie rod attaching parts 40g are formed on a rear part of the tie rod attaching member 40f, and tie rods 21 on the arrow L side and the arrow R side are attached to the paired tie rod attaching part 40g. Thus, when the pitman arm 40 (tie rod attaching member 40f) is rotated in the A6 direction (clockwise), the arrow L side (left) tie rod 21 can be moved in the arrow A7 direction (leftward) and the arrow R side (right) tie rod 21 can be moved in the arrow A8 direction (leftward). When the pitman arm 40 (tie rod attaching member 40f) is rotated in the B6 direction (leftward), the arrow L side (left) tie rod 21 is moved in the arrow B7 direction (rightward) and the arrow R side (right) tie rod 21 is moved in the arrow B8 direction (rightward). Therefore, when the pitman arm 40 is rocked in the arrow A6 direction (clockwise) or the arrow B6 direction (counterclockwise), a steering angle in the arrow R direction (rightward) or in the arrow L direction (leftward), which is opposite to the direction for the front wheels 8, can be provided to the rear wheels 11 to which the tie rods 21 are attached via the hubs 12.

In this embodiment, since the rocking member 38 and the pitman arm 40 are constituted as described above, when the rocking member 38 is rotated in the A5 direction (counterclockwise) through an angle smaller than a prescribed angle, the paired receiving parts 38c of the rocking member 38 are in contact with the paired roller parts 40a of the pitman arm 40 to prevent the pitman arm 40 from being rocked about the pivot shaft part 40e. On the other hand, when the rocking member 38 is rotated in the A5 direction (counterclockwise) through an angle equal to or greater than a prescribed angle, the rocking member 38 is rotated to the extent that the contact with the receiving parts 38c is released. Therefore, when the paired roller parts 40a of the pitman arm 40, which have been in contact with the paired receiving parts 38c of the rocking member 38, are released from the contact with the receiving parts 38c, the pitman arm 40 can be rocked in the A6 direction (clockwise). That is, the rocking member 38 and the pitman arm 40 are configured not to provide a steering angle to the rear wheels 11 when the front wheels 8 are steered in the arrow L direction or the arrow R direction by an angle smaller than a prescribed steering angle (approximately 35°) with respect to the arrow FWD direction. Also, the rocking member 38 and the pitman arm 40 are configured to provide a steering angle in a direction opposite to the direction for the front wheels 8 to the rear wheels 11 when the front wheels 8 are steered in the arrow L direction or the arrow R direction by an angle equal to or greater than a prescribed steering angle (approximately 35°) with respect to the arrow FWD direction.

Referring next to FIG. 1, FIG. 3 to FIG. 5 and FIG. 8 to FIG. 11, the operation during running of the ATV (all terrain vehicle) according to the embodiment of the present invention is described.

First, the operation of the front wheel steering mechanism 34 and the rear wheel steering mechanism 41 when the ATV (all terrain vehicle) according to this embodiment is steered in the arrow L direction and the steering angle provided to the front wheels 8 is between approximately 0° and approximately 35° is described.

When the rider steers the handle bar 22 (see FIG. 1) in the A1 direction (counterclockwise) (see FIG. 5) from the straight-ahead running state shown in FIG. 3, the upper shaft part 24 is rotated in the A1 direction (see FIG. 5) as shown in FIG. 4. The steering force applied by the rider to steer the handle bar 22 (see FIG. 1) is transmitted to the front wheels 8 (see FIG. 3) via the torsion bar 26, the lower shaft part 25, the pitman arm 31, the tie rods 20 and the hubs 9 (see FIG. 3). At this time, a resistive force in the B1 direction (clockwise) (see FIG. 5) is applied to the pitman arm 31 against the steering force in the A1 direction (see FIG. 5) because of the friction between the front wheels 8 (see FIG. 3) and the ground surface. Then, a resistive force in the B1 direction (see FIG. 5) is also applied to the lower shaft part 25, and a twist in the rotation direction about the axis of rotation L1 is generated in the torsion bar 26 between the upper shaft part 24 and the lower shaft part 25. At this time, the torque of the torsion bar 26 generated when the torsion bar 26 is twisted is detected by the potentiometer 27, and the driving force to be outputted from the motor 30 is controlled based on the torque of the torsion bar 26.

That is, when the friction between the front wheels 8 (see FIG. 3) and the ground surface is large, a large twist is applied to the torsion bar 26. Then, the torque of the torsion bar 26 increases and the driving force to be outputted from the motor 30 is controlled to increase. When the friction between the front wheels 8 (see FIG. 3) and the ground surface is small, a small twist is applied to the torsion bar 26. Then, the torque of the torsion bar 26 decreases and the driving force to be outputted from the motor 30 is controlled to decrease.

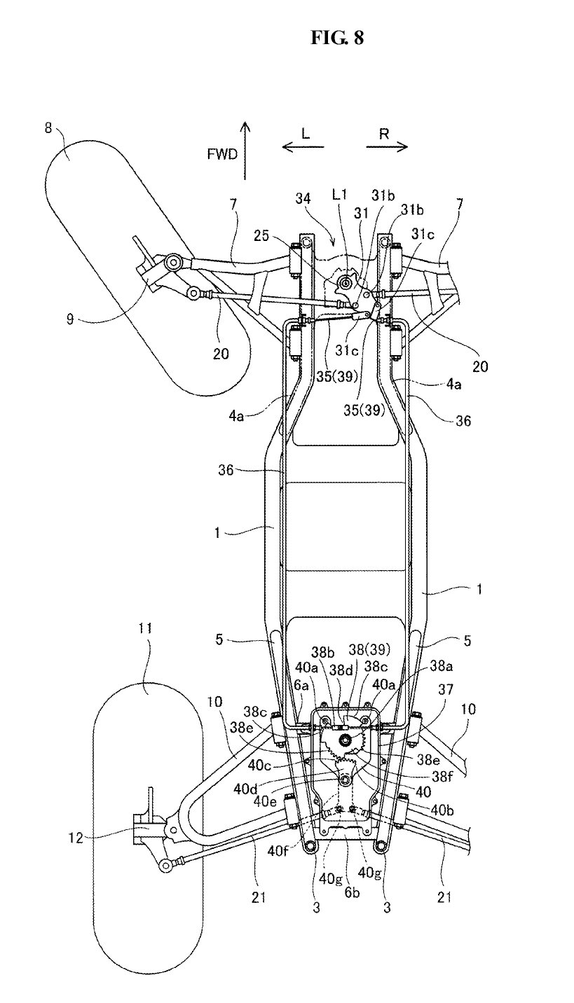

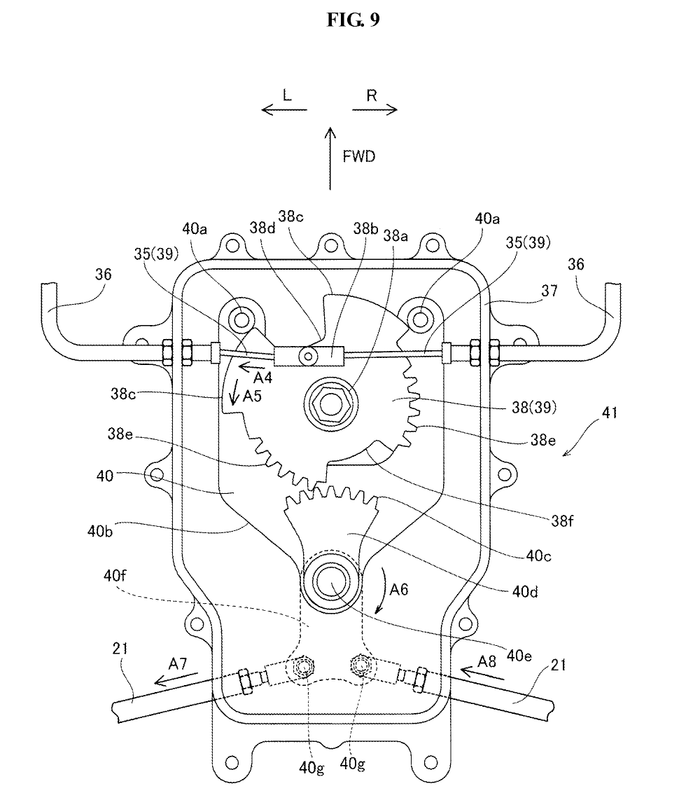

Then, the pitman arm 31 is rocked in the A1 direction as shown in FIG. 5. Then, the arrow L side (left) tie rod 20 is moved in the arrow A2 direction (rightward) (see FIG. 5) as shown in FIG. 8, and the arrow L side front wheel 8 is rotated in the arrow L direction. Also, the arrow R side (right) tie rod 20 is moved in the arrow A3 direction (rightward) (see FIG. 5), and the arrow R side front wheel 8 is rotated in the arrow L direction. As a result, the ATV (all terrain vehicle) according to this embodiment is steered in the arrow L direction. When the pitman arm 31 is rocked in the A1 direction, the wire members 35 connected to the wire attaching parts 31c are moved in the arrow A4 direction (see FIG. 5). Then, the rocking member 38 is rotated in the A5 direction (counterclockwise) about the pivot shaft part 38a as shown in FIG. 9. At this time, since the gear part 40c of the pitman arm 40 is in meshing engagement with neither of the gear parts 38e of the rocking member 38, the pitman arm 40 is not rocked.

Next, the operation of the front wheel steering mechanism 34 and the rear wheel steering mechanism 41 when the ATV (all terrain vehicle) according to this embodiment is steered in the arrow L direction and the steering angle provided to the front wheels 8 is between approximately 35° and approximately 40° is described.

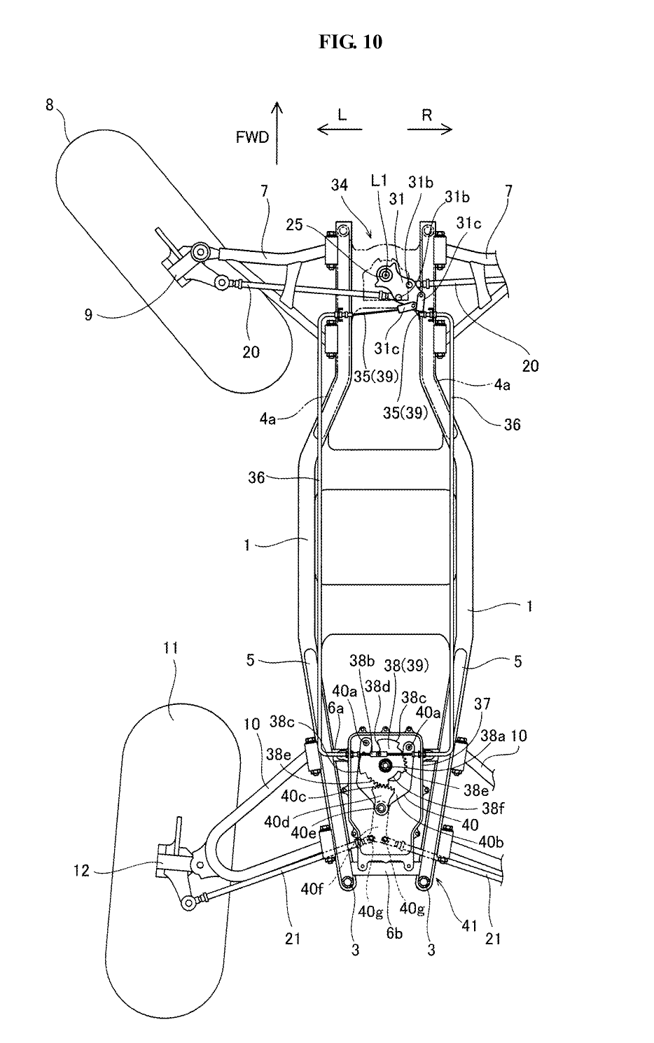

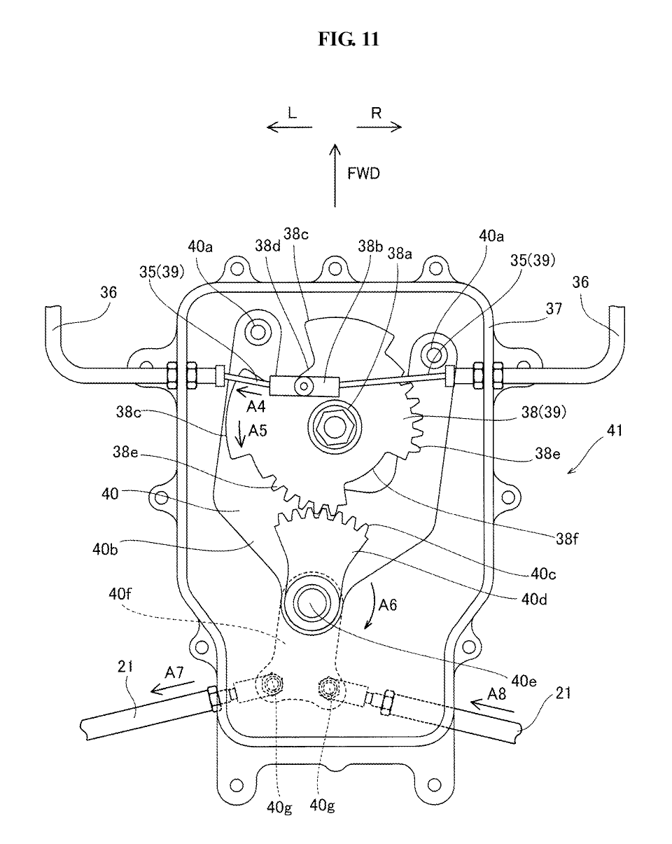

When the rider further steers the handle bar 22 (see FIG. 1) in the A1 direction (see FIG. 5) from the running state shown in FIG. 8, the pitman arm 31 is further rocked in the A1 direction (see FIG. 5). At this time, the arrow L side tie rod 20 is further moved in the arrow A2 direction (see FIG. 5) as shown in FIG. 10, and the arrow L side front wheel 8 is further rotated in the arrow L direction. Also, the arrow R side tie rod 20 is further moved in the arrow A3 direction (see FIG. 5), and the arrow R side front wheel 8 is further rotated in the arrow L direction. In addition, the wire members 35 connected to the wire attaching parts 31c are further moved in the arrow A4 direction (see FIG. 5). Then, the rocking member 38 is further rotated in the A5 direction about the pivot shaft part 38a as shown in FIG. 11.

Then, one of the gear parts 38e of the rocking member 38 is brought into meshing engagement with the gear part 40c of the pitman arm 40. At this time, since the resistive force against the steering force by which the rider steers the handle bar 22 (see FIG. 1) increases, the output from the motor 30 (see FIG. 4) is controlled to increase in this embodiment. Also, at this time, the contact between the paired receiving parts 38c and paired roller parts 40a is released, the pitman arm 40 is rocked in the A6 direction (clockwise) about the pivot shaft part 40e. Thus, the arrow L side tie rod 21 is moved in the arrow A7 direction (leftward), and the arrow R side tie rod 21 is moved in the arrow A8 direction (leftward). That is, the rear wheels 11 are rotated in the arrow R direction, which is opposite to the arrow L direction, in which the front wheels 8 are rotated, as shown in FIG. 10. Therefore, the ATV (all terrain vehicle) according to this embodiment can be steered further in the arrow L direction. That is, the turning radius can be decreased.

In this embodiment, since the rear wheel steering mechanism 41 connected to the front wheel steering mechanism 34 via the transmission mechanism 39 for providing a steering angle to the rear wheels 11 is provided as described above, a steering angle in a direction opposite to the direction of a steering angle provided to the front wheels 8 can be provided to the rear wheels 11. Therefore, the turning radius of the ATV can be decreased. As a result, the steering performance of the ATV can be improved. Also, since the motor 30 for assisting the steering force to provide a steering angle to the front wheels 8 is provided and since the rear wheel steering mechanism 41 is connected to the front wheel steering mechanism 34, the driving force of the motor 30 can be also used as the driving force for the rear wheel steering mechanism 41. Therefore, the steering force the rider needs to provide a steering angle to the front wheels 8 and the rear wheels 11 can be decreased.

Also, in this embodiment, the rear wheel steering mechanism 41 is configured to provide a steering angle to the rear wheels 11 when a steering angle of approximately 35° or greater with respect to the arrow FWD direction is provided to the front wheels 8. Therefore, since the turning radius of the ATV can be decreased only when the rider wants to make a turn or the like, the steering performance of the ATV can be improved.

Also, in this embodiment, when the pitman arm 31 of the front wheel steering mechanism 34 is rocked in the A1 direction, the tie rods 20 are moved in the arrow A2 direction and the arrow A3 direction to steer the front wheels 8 in the arrow L direction and the rocking member 38 of the transmission mechanism 39 is rocked in the A5 direction via the wire members 35 movable in the arrow A4 direction. When the rocking member 38 is rocked in the A5 direction, the gear parts 38e of the rocking member 38 are rotated in the A5 direction and the gear part 40c of the pitman arm 40 of the rear wheel steering mechanism 41 is rotated in the A6 direction. Then, the pitman arm 40 is rocked in the A6 direction, and the tie rods 21 are moved in the arrow A7 direction and the arrow A8 direction to steer the rear wheels 11 to the arrow R direction. Therefore, a steering angle in the arrow R direction opposite to the arrow L direction of which steering angle provided to the front wheels 8, can be easily provided to the rear wheels 11.

Also, in this embodiment, the pitman arm 40 of the rear wheel steering mechanism 41 has roller parts 40a which are kept in contact with the rocking member 38 when a steering angle smaller than approximately 35° with respect to the arrow FWD direction is provided to the front wheels 8 and which are released from the contact with the rocking member 38 when a steering angle equal to or greater than approximately 35° with respect to the arrow FWD direction is provided to the front wheels 8. Thus, when a steering angle smaller than approximately 35° with respect to the arrow FWD direction is provided to the front wheels 8, the rocking members 38 is in contact with the roller parts 40a to prevent the pitman arm 40 from being rocked because of and no steering angle is provided to the rear wheels 11. When a steering angle equal to or greater than approximately 35° with respect to the arrow FWD direction is provided to the front wheels 8, the rocking member 38, which has been in contact with the roller parts 40a, is released from the contact with the roller parts 40a to allow the pitman arm 40 to be rocked. Therefore, a steering angle in a direction opposite to the direction for the front wheels 8 can be provided to the rear wheels 11.

It is to be understood that the embodiment disclosed herein is illustrative and not restrictive in all respects. The scope of the present invention is defined not by the above description of the embodiment but by the claims and includes all the equivalents of the appended claims and modifications within the scope of the present invention.

For example, a four-wheeled ATV (all terrain vehicle) is shown as an example of all terrain vehicle in the above embodiment, the present invention is not limited thereto but applicable to other all terrain vehicles provided with a front wheel steering mechanism and a rear wheel steering mechanism such as CCV (Cross Country Vehicle), SSV (Side-by-Side Vehicle) and tractor. Also, a four-wheeled ATV (all terrain vehicle) is shown as an example of all terrain vehicle in the above embodiment, the present invention is not limited thereto but applicable to all terrain vehicles provided with a front wheel steering mechanism and a rear wheel steering mechanism other than four-wheeled all terrain vehicles.

In addition, an example in which the rear wheels of the rear wheel steering mechanism are steered in a direction opposite to the direction in which the front wheels of the front wheel steering mechanism are steered is shown in the above embodiment, the present invention is not limited thereto. The rear wheels of the rear wheel steering mechanism may be steered in the same direction as the front wheels of the front wheel steering mechanism.

In addition, an example in which a motor is provided to assist the steering force to provide a steering angle to the front wheels and the rear wheels is shown in the above embodiment, the present invention is not limited thereto. A device for assisting the steering force such as a hydraulic cylinder may be provided to assist the steering force to provide a steering angle to the front wheels and the rear wheels.

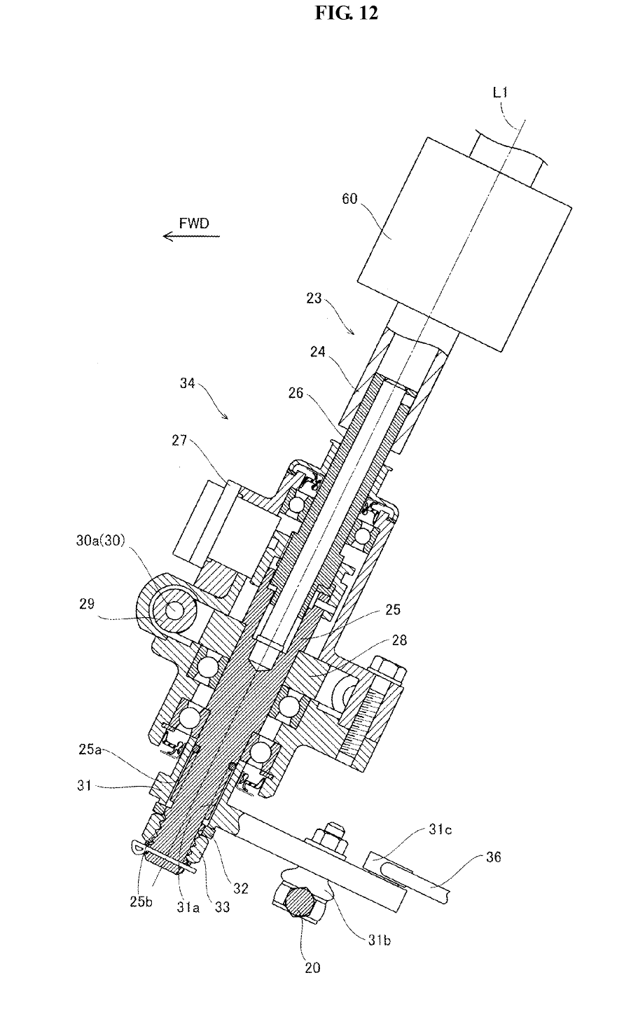

In addition, an example in which the driving force of the motor 30 is controlled based on the torque detected by the potentiometer 27 in the above embodiment, the present invention is not limited thereto. A steering angle detection device 60 for detecting the rotational angle of the upper shaft part 24 may be provided as in an ATV according to a modification of this embodiment shown in FIG. 12. At this time, the driving force of the motor 30 may be controlled by the potentiometer 27 and the steering angle detector 60.

1. A vehicle including front and rear wheels comprising:
a front wheel steering mechanism for providing a steering angle to a front wheel;
a rear wheel steering mechanism for providing a steering angle to a rear wheel;
said rear wheel steering mechanism having a first and second operational position; and
said second operational position of said rear wheel steering mechanism being dependent upon said front wheel steering mechanism achieving a first predetermined steering state.

2. The vehicle of claim 1 wherein said first predetermined steering state exists when the front wheel steering mechanism is steered through a prescribed angle or greater.

3. The vehicle according to claim 1 wherein the front wheel steering mechanism includes a first rocking member which is rocked when a steering angle is provided to a front wheel; and a front wheel moving member connected to the first rocking member for providing a steering angle to a front wheel when the first rocking member is rocked.

4. The vehicle of claim 1 further including a driving source operationally coupled to said front wheel steering mechanism for assisting a steering force to provide a steering angle to a front wheel.

5. The vehicle of claim 4 wherein said driving source is operationally coupled to said rear wheel steering mechanism for assisting a steering force to provide a steering angle to a rear wheel.

6. The vehicle according to claim 5 further comprising a transmission mechanism for transmitting the steering force of the front wheel steering mechanism assisted by the driving source to the rear wheel steering mechanism,
wherein the transmission mechanism includes a transmitting member connected to the first rocking member of the front wheel steering mechanism for transmitting the steering force of the front wheel steering mechanism to the rear wheel steering mechanism side; and a second rocking member which is connected to the transmitting member and which is rocked by the steering force of the front wheel steering mechanism transmitted by the transmitting member to transmit the steering force of the front wheel steering mechanism to the rear wheel steering mechanism.

7. The vehicle according to claim 6 wherein the transmission mechanism includes a wire member.

8. The vehicle according to claim 6 wherein the rear wheel steering mechanism includes a third rocking member which is rocked when the second rocking member of the transmission mechanism is rocked; and a rear wheel moving member for providing a steering angle to a rear wheel when the third rocking member is rocked.

9. The vehicle according to claim 8 wherein the second rocking member of the transmission mechanism includes a first gear part,
and wherein the third rocking member of the rear wheel steering mechanism includes a second gear part which can be brought into meshing engagement with the first gear part.

10. The vehicle according to claim 9 wherein the first gear part of the transmission mechanism is brought into meshing engagement with the second gear part of the rear wheel steering mechanism when the front wheel steering mechanism is steered through a prescribed angle or greater.

11. The vehicle according to claim 9 wherein when the first rocking member of the front wheel steering mechanism is rocked in one direction, the front wheels are steered in one direction, and the second rocking member is rocked in one direction via the transmitting member of the transmission mechanism, and when the first gear part of the second rocking member is rotated in one direction, the second gear part of the third rocking member of the rear wheel steering mechanism is rotated in the opposite direction, whereby the third rocking member is rocked in the opposite direction and the rear wheels are steered in the opposite direction.

12. The vehicle according to claim 8 wherein the third rocking member of the rear wheel steering mechanism includes a roller part which is brought into contact with the second rocking member when the front wheel steering mechanism is steered through an angle smaller than a prescribed angle, and which is released from the contact with the second rocking member when the front wheel steering mechanism is steered through a prescribed angle or greater.

13. The vehicle according to claim 4 wherein the driving source includes a motor having a drive shaft extending in a direction across a steering shaft of the front wheel steering mechanism.

14. The all terrain vehicle according to claim 4 wherein the front wheel steering mechanism further includes a steering force detection device for detecting the steering force applied to the front wheel steering mechanism, and wherein the driving force to assist the steering force is controlled based on the magnitude of the steering force and detected by the steering force detection device.

15. The vehicle according to claim 14 wherein the driving force is greater when the front wheel steering mechanism is steered through a prescribed angle or greater than when the front wheel steering mechanism is steered through an angle smaller than the prescribed angle.

16. The vehicle according to claim 4 wherein the front wheel steering mechanism further includes a steering angle detection device for detecting the steering angle provided by a rider when the front wheel steering mechanism is steered, and
wherein the driving source to assist the steering force is controlled based on the steering angle provided by a rider when the steering angle provided by a rider is detected by the steering angle detection device.

17. The vehicle according to claim 1 further comprising:
an engine;
a front output shaft for transmitting a driving force from the engine to the front wheels;
a rear output shaft for transmitting a driving force from the engine to the rear wheels; and
a differential device provided between the front output shaft and the front wheels for connecting and disconnecting the driving force to be transmitted to the front wheels.

18. The vehicle according to claim 1 characterized by being a four-wheeled vehicle.

19. An all terrain vehicle having front and rear wheels comprising:
a front wheel steering mechanism for providing a steering angle to a front wheel;
a rear wheel steering mechanism for providing a steering angle to a rear wheel;
said rear wheel steering mechanism operationally coupled to said front wheel steering mechanism such that said rear wheel steering mechanism provides a steering angle to a rear wheel when said front wheel steering mechanism is steered through a prescribed angle or greater;
a driving source operationally coupled to said front wheel steering mechanism for providing assistance to said front wheel steering mechanism when a steering force is applied by a rider to provide a steering angle to a front wheel.

20. The all terrain vehicle of claim 19 wherein said rear wheel steering mechanism is interconnected with said front wheel steering mechanism via a transmission mechanism including a rotatable linkage, said driving source being operationally coupled to said rear wheel steering mechanism via said transmission mechanism.
